(19) United States
(12) Patent Application Publication
(10) Pub. No.: US 2024/0119869 A1
(43) Pub. Date: Apr. 11, 2024

(54) FACELESS PRESSURE-SENSITIVE LABEL AND METHOD OF PREPARING THE SAME

(71) Applicant: Multi-Color Corporation, Batavia, OH (US)

(72) Inventors: Barron G. McKillip, Batavia, OH (US); Justin G. Long, Cincinnati, OH (US); Benjamin M. Wolfe, Columbus, OH (US); A. Craig Bushman, Loveland, OH (US)

(21) Appl. No.: 18/484,687

(22) Filed: Oct. 11, 2023

Related U.S. Application Data
(60) Provisional application No. 63/379,014, filed on Oct. 11, 2022.

(51) Int. Cl. G09F 3/02; G09F 3/10

(52) U.S. Cl. CPC G09F 3/02; G09F 3/10; G09F 2003/0241; G09F 2003/0257

(57) ABSTRACT

A pressure-sensitive label is provided. The pressure-sensitive label includes a support portion including a carrier layer and a transfer portion operatively connected to the support portion. The transfer portion includes at least an adhesive layer and an indicia layer. The transfer portion does not include a face stock layer. The transfer portion is configured for transfer of the transfer portion from the support portion to an article upon application of pressure to the transfer portion while the transfer portion is in contact with the article. A method of making a pressure-sensitive label is also provided. The method includes providing a first carrier layer, applying an indicia layer atop the first carrier layer, applying an adhesive layer atop the indicia layer, and applying a second carrier layer atop the adhesive layer.

### RELATED APPLICATION

This application claims the benefit of the filing date of U.S. Provisional Patent Application Ser. No. 63/379,014, filed Oct. 11, 2022, the disclosure of which is incorporated by reference herein in its entirety.

### TECHNICAL FIELD

The present invention relates generally to labels for various articles and relates, more specifically, to pressure-sensitive labels for articles, such as containers, and methods of producing the same.

### BACKGROUND

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Pressure-sensitive labels are multi-layered constructions that generally include a pressure-sensitive adhesive, and are used to label articles by applying pressure to the label when the label is in contact with the article. Such pressure-sensitive labels are popular because, among other characteristics, pressure-sensitive labels are versatile and allow for a high level of printability with bright colors printed on surfaces. Pressure-sensitive labels are also compatible with a wide array of finishing processes including perforating, embossing, and hot stamping, for example. However, there are many drawbacks to the use of conventional pressure-sensitive labels. For example, conventional pressure-sensitive labels typically require a face stock layer upon which an ink layer, for example, can be applied to create the label decoration and information. Face stock has a solid backing and may be made from a web or sheet of paper, film, foil, vinyl, polyester, polyethylene, polypropylene, or coextruded polyolefin, for example. The thickness of a face stock layer may be in the range of about 40 to about 100 microns. Face stocks in a range of about 50 microns to about 80 microns are in a typical range of thickness for face stocks, while those having a thickness of about 40 to about 50 microns are generally considered thin face stocks, and those having a thickness above about 80 microns are generally considered thick face stocks. There may be face stock substrates that are thinner than 40 microns (e.g., down to about 18 microns); however, such face stocks are uncommon and, when used, are not used as a single layer, but are paired with other substrates to form a laminated construction.

The need for this face stock layer adds materials, thickness, and thus cost, to conventional pressure-sensitive labels. Further, where the label is to be adhered to a contoured or irregular surface, and where a high degree of flexibility is desired, the rigidity of the face stock (e.g., due to materials of face stock and/or due to the thickness) may interfere with the application and the adherence of the label. For example, application of a label including a face stock layer to a contoured or irregular surface may result in various defects, such as wrinkles and blisters. Additionally, the use of face stock prevents a “no-label” look (i.e., a label that provides the appearance of graphics printed directly on the container) because the face stock is visible (although pressure sensitive labels are often still used because direct-to-container printing is very limited in the graphics and colors that can be applied). The result of all of the above is less than optimum visual appeal (e.g., poor aesthetics), label failure due to scuffing or tearing of the unsupported label, or even unsellable products.

In view of the many drawbacks of pressure-sensitive labels that include a face stock layer, it would be desirable to provide a pressure-sensitive label that avoids, alleviates, or otherwise minimizes the drawbacks or shortcomings of conventional pressure-sensitive labels that include a face stock layer. It is further desirable that the pressure-sensitive label construction have printability, convertibility, and dispensability properties that are better than or equal to that of conventional pressure-sensitive label constructions including a face stock layer (as described above). It is also desirable that such a pressure-sensitive label construction be designed in a manner to reduce the amount of manufacturing time needed to complete same, when compared to a pressure-sensitive label construction that includes a face stock layer. Further, it would be desirable to reduce and/or eliminate wrinkles and/or blisters that may form during label application. Further, it would be desirable to achieve a “no-label” look (to mimic direct-to-container printing, while allowing for better and more vibrant graphics). Further, it would be desirable for such a pressure-sensitive label construction to have reduced layers (and thus reduced cost), increased recyclability, increased ease of application to an article being labeled, and a reduced incidence or likelihood of damage to the ink layer.

### SUMMARY

Certain exemplary aspects of the invention are set forth below. It should be understood that these aspects are presented merely to provide the reader with a brief summary of certain forms the invention might take and that these aspects are not intended to limit the scope of the invention.

In a first aspect of the invention, a pressure-sensitive label is disclosed. The pressure-sensitive label includes a support portion including a carrier layer and a transfer portion operatively connected to the support portion. The transfer portion includes at least an adhesive layer and an indicia layer. The transfer portion does not include a face stock layer. The transfer portion is configured for transfer of the transfer portion from the support portion to an article upon application of pressure to the transfer portion while the transfer portion is in contact with the article.

In one embodiment, the transfer portion may include a printable layer. The printable layer may be positioned such that the printable layer is between the indicia layer and the adhesive layer. The printable layer may be clear. Further, the carrier layer may include a first carrier layer and a second carrier layer. And, the transfer portion may be positioned such that the transfer portion is between the first carrier layer and the second carrier layer.

In one embodiment, the transfer portion may include a varnish layer. Further, the transfer portion may include a printable layer and the printable layer may be positioned such that the printable layer is located between the varnish layer and the indicia layer. Further, the transfer portion may include a foil layer separate from the indicia layer. Further, the transfer portion may include a screen printed graphics layer separate from the indicia layer. Further, the varnish layer may include a first varnish layer and a second varnish layer, the first varnish layer separate from the second varnish layer.

In another aspect of the invention, a method of making a pressure-sensitive label is disclosed. The method includes providing a first carrier layer, applying an indicia layer atop the first carrier layer, applying an adhesive layer atop the indicia layer, and applying a second carrier layer atop the adhesive layer. The first carrier layer and the second carrier layer form a support portion. The indicia layer and the adhesive layer form at least a portion of a transfer portion. The transfer portion is configured for transfer of the transfer portion to an article upon application of pressure to the transfer portion while the transfer portion is in contact with the article.

In one embodiment, the method may further include, prior to the step of applying the second carrier layer, applying a first varnish layer atop the first carrier layer and applying a printable layer atop the first varnish layer. The first varnish layer and the printable layer may form at least a portion of the transfer portion. The printable layer may be positioned such that the printable layer is between the first varnish layer and the indicia layer. Alternatively, the printable layer may be positioned such that the printable layer is between the indicia layer and the adhesive layer.

In one embodiment, the method may further include, after the step of applying the second carrier layer, flipping an orientation of the pressure-sensitive label. The orientation of the pressure-sensitive label may be flipped by a turn bar.

In one embodiment, the method may further include, after the step of flipping the orientation of the label, removing the first carrier layer and applying at least one first label enhancement layer atop the indicia layer. The at least one first label enhancement layer may form at least a portion of the transfer portion. The at least one first label enhancement layer may include foil. The method may further include, after the step of applying at least one first label enhancement layer, applying a second varnish layer atop the at least one at least one first label enhancement layer. The second varnish layer may form at least a portion of the transfer portion. The method may further include, after the step of applying a second varnish layer, applying at least one second label enhancement layer atop the second varnish layer. The at least one second label enhancement layer may form at least a portion of the transfer portion. The at least one second label enhancement layer may include screen printed graphics.

### BRIEF DESCRIPTION OF THE DRAWINGS

The accompanying drawings, which are incorporated in and constitute a part of this specification, illustrate embodiments of the invention and, together with the Detailed Description given below, serve to explain the invention.

FIG. 1A is a cross-sectional view of one embodiment of a pressure-sensitive label construction in accordance with principles of the present invention.

FIG. 1B is a cross-sectional view of the pressure-sensitive label of FIG. 1A after being flipped in orientation, showing a carrier film layer being removed.

FIG. 2 is a schematic showing the preparation of the pressure-sensitive labels of FIGS. 1A and 1B.

FIG. 3A is a schematic showing the preparation of the pressure-sensitive label of FIG. 1A.

FIG. 3B is a schematic showing the preparation of the pressure-sensitive label of FIG. 1B.

FIG. 4A is a cross-sectional view of another embodiment of a pressure-sensitive label construction in accordance with principles of the present invention.

FIG. 4B is a cross-sectional view the pressure-sensitive label of FIG. 4A after being flipped in orientation, showing a carrier film layer being removed.

FIG. 4C is a cross-sectional view the pressure-sensitive label of FIG. 4B, including additional layers.

FIG. 5 is a schematic showing the preparation of the pressure-sensitive labels of FIGS. 4A-4C.

FIG. 6A is a schematic showing the preparation of the pressure-sensitive label of FIG. 4A.

FIG. 6B is a schematic showing the preparation of the pressure-sensitive labels of FIGS. 4B and 4C.

FIG. 7 is a cross-sectional view of another embodiment of a pressure-sensitive label construction in accordance with principles of the present invention.

### DETAILED DESCRIPTION OF THE INVENTION

The exemplary embodiments described herein are provided for illustrative purposes and are not limiting. Other exemplary embodiments are possible, and modifications may be made to the exemplary embodiments within the scope of the present disclosure. Therefore, this Detailed Description is not meant to limit the scope of the present disclosure.

As described above, there presently are drawbacks of conventional pressure-sensitive labels. Referring now to the Figures, embodiments of a pressure-sensitive label 10 and process 24 for producing the same in accordance with principles of the present invention are shown. Various aspects of the present invention address the drawbacks described above with pressure-sensitive labels including a face stock layer by providing pressure-sensitive labels 10 that, among other characteristics, have reduced layers, reduced cost, increased recyclability, increased ease of application to an article being labeled, and reduced incidence or likelihood of damage to an ink layer (as compared to pressure-sensitive labels including a face stock layer, as described in the Background). Further, pressure-sensitive labels 10 in accordance with principles of the present invention (e.g., using only ink, coatings, and adhesive components with no face stock layer) can be prepared (e.g., according to process 24) and applied with conventional pressure-sensitive label machinery (thus avoiding the need for specialized machinery). Further, pressure-sensitive labels 10 prepared in accordance with principles of the present invention are highly conformable, flexible, and malleable and effectively decorate an article while also limiting the potential for label defects such as darting or wrinkling. Further, pressure-sensitive labels prepared in accordance with principles of the present invention can also provide a “no-label” look while allowing for enhanced graphics over direct-to-container printing. Other advantages and technical effects of the embodiments of this invention will become evident to one skilled in the art from the following description.

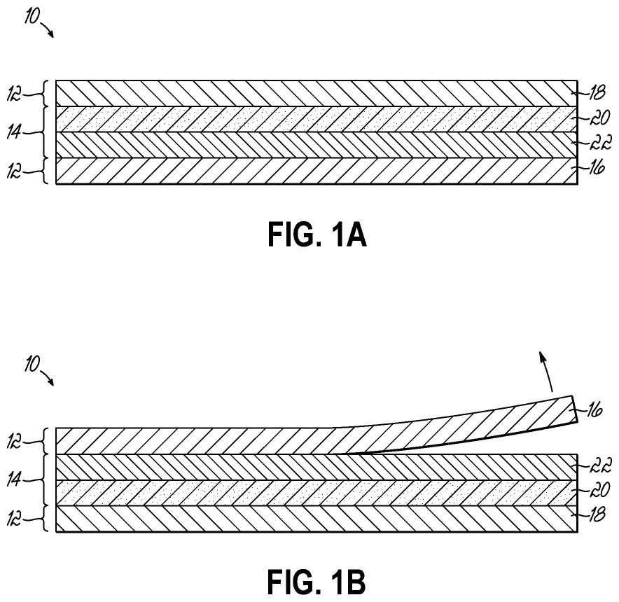

Referring generally to FIGS. 1A-7, embodiments of a pressure-sensitive label 10 and embodiments of a process 24 (or portions thereof) for preparing the same in accordance with principles of the present invention are shown. Unlike conventional pressure-sensitive labels, the pressure-sensitive label 10 of the present invention does not require the use of a face stock layer. In certain embodiments, the pressure-sensitive label 10 of the present invention further does not require a printable layer. To achieve such a label 10 construction, an alternative (e.g., from what is conventional) process 24 is utilized. The process 24 allows for embodiments of a pressure-sensitive label 10 to be manufactured with inks and adhesive chemistries only (e.g., without need for a face stock layer as is conventionally required). In addition to not utilizing a face stock layer, a further difference between the process 24 and a conventional process for preparing a conventional pressure-sensitive label is that the pressure-sensitive label 10 of the present invention is flipped in orientation during the process 24 (e.g., during or after printing). Such flipping allows for conventional pressure-sensitive label machinery and technology to be used for the process 24 with little or no modifications necessary, and also facilitates the preparation of the pressure-sensitive label 10. This reduces the costs associated with converting from one decorating technology to another and eliminates the need for additional specialized machinery. Further, such flipping allows for the pressure-sensitive label 10 to be constructed without a face stock layer and then be applied to an article, such as a container, for example, also using conventional pressure-sensitive label machinery and technology.

Beginning with reference to FIG. 1A, an embodiment of a pressure-sensitive label 10 in accordance with principles of the present invention is shown. The pressure-sensitive label 10 of FIG. 1A features a multi-layered construction, with each layer having its own function. In general, the label 10 includes a support portion 12 and a transfer portion 14. As will be described in greater detail below, the support portion 12 and the transfer portion 14 each include of one or more layers. It is to be understood that alternative embodiments of the pressure-sensitive label 10 may include additional or fewer portions and/or layers.

In the embodiment depicted in the FIG. 1A, the support portion 12 includes a first carrier layer 16 and a second carrier layer 18. The carrier layers 16, 18 allow the transfer portion 14 of the label 10 to separate from the support portion 12 (e.g., carrier layers 16, 18) without the need for a separate release layer (though a release layer may be utilized if desired). This allows for the reduction in materials used and cost incurred to create the label 10. To that end, one or more of the carrier layers 16, 18 may include a release coating (e.g., a wax or silicone coating) on one or both sides thereof (e.g., to enhance release of the transfer portion 14 from the first carrier layer 16 or second carrier layer 18, and/or to prevent blocking when a web of labels 10 is wound on a roll; a release coating provided on the exposed surface of second carrier layer 18, for example, would prevent blocking when that surface confronts other labels when wound on a roll). Alternatively, one or more of the carrier layers 16, 18 may include no release coating, but may be otherwise treated (e.g., by a corona treatment) to facilitate release between the support portion 12 and the transfer portion 14. In further alternative embodiments, the carrier layers 16, 18 may be untreated and have no release coating.

With continued reference to FIG. 1A, the transfer portion 14 is sandwiched between the first and second carrier layers 16, 18 of the support portion 12. The transfer portion 14 is positioned adjacent to, and in confronting relationship with, the first and second carrier layers 16, 18 prior to transfer therefrom. The transfer portion 14 includes an adhesive layer 20 and an indicia layer 22. As will be described in greater detail below, additional layers may be included within the transfer portion 14. With respect to the particular embodiment depicted in FIG. 1A, the indicia layer 22 is disposed between and in confronting relationship with the first carrier layer 16 and the adhesive layer 20. In embodiments of the present invention, the first carrier layer 16 is of, or includes, a material having a surface tension that allows the indicia layer 22 to releasably bond thereto. The adhesive layer 20 is disposed between and in confronting relationship with the indicia layer 22 and the second carrier layer 18. The adhesive of the adhesive layer 20 may be UV, solvent, aqueous, or similar and may be applied (e.g., printed or similar) by various means. Such a confronting relationship between the layers 20, 22 of the transfer portion 14 and the layers 16, 18 of the support portion 12 does not necessarily require contact between the layers. The layers merely need be proximal and adjacent one another, though there may be one layer or coating therebetween. For example, there may be a release coating (or layer) between the first carrier layer 16 and the indicia layer 22 and/or between the second carrier layer 18 and the adhesive layer 20.

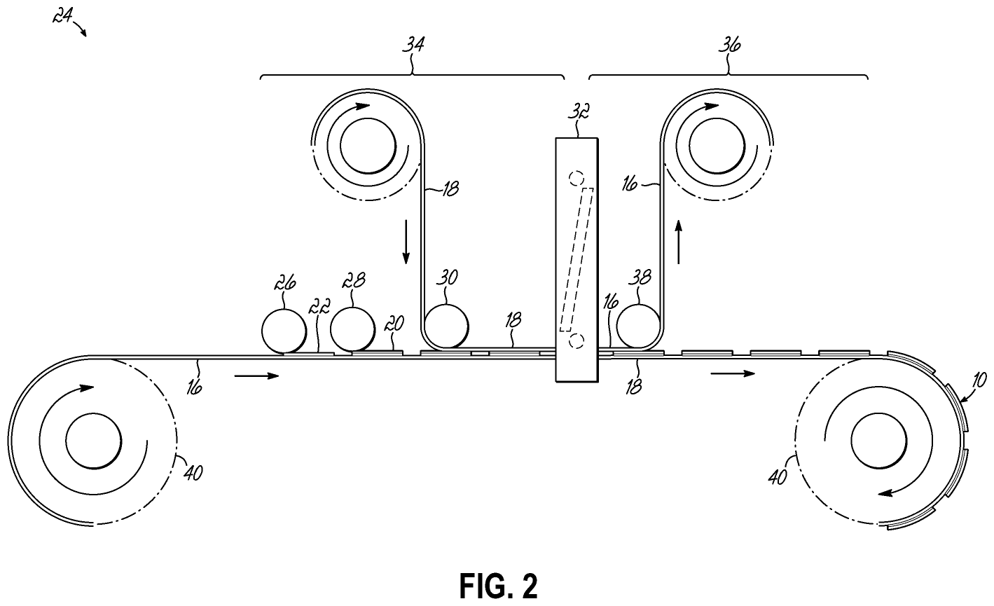

Referring now to FIG. 1B, the pressure-sensitive label 10 of FIG. 1A is shown in a flipped orientation. Particularly, the label 10 of FIG. 1A is flipped about an axis such that the second carrier layer 18 (previously the top most layer in FIG. 1A) has become the bottom most layer in FIG. 1B. Similarly, the first carrier layer 16 (previously the bottom most layer in FIG. 1A) has become the top most layer in FIG. 1B. The process by which the label 10 flips from the orientation shown in FIG. 1A to the orientation shown in FIG. 1B is explained in greater detail below (with reference to FIG. 2, for example). Generally, the construction of the label 10 is flipped (e.g., from the orientation shown in FIG. 1A to the orientation shown in FIG. 1B) to replicate a “conventional” pressure-sensitive label (e.g., a label that includes a face stock layer), but one that is created using only inks and coatings (i.e., without a face stock).

Further, in FIG. 1B, the first carrier layer 16 is shown being removed (e.g., peeled) from the pressure-sensitive label 10. Such is addressed in greater detail below, but, at a high-level, the first carrier layer 16 is removed from the pressure-sensitive label 10 to expose the indicia layer 22 so that the label 10 can be further enhanced (e.g., visually with additional embellishments, gloss, or similar). For example, additional graphic elements (e.g., screen printed and/or foil elements) could be added on top of the exposed indicia layer 22 to further enhance the label 10. After the first carrier layer 16 is removed and any desired additional enhancements have been added to the label 10, the label 10 is ready to be applied to an article, such as a container, for example. To that end, when subjected to pressure, the transfer portion 14 of the label 10 may be separated from the support portion 12 of the label 10 (e.g., the second carrier layer 18) to adhere the transfer portion 14 of the pressure-sensitive label 10 to an article. This can occur when the label 10 is placed in a confronting relationship with an article (e.g., a container or similar) and pressure is applied, such that the transfer portion 14 makes direct contact with an outer surface of the article. After contact of the transfer portion 14 to the article, the support portion 12 is removed, leaving the transfer portion 14 affixed to the article.

As described above, another aspect of the present invention may include a method or methods for making a pressure-sensitive label 10. Referring now to FIG. 2, the pressure-sensitive label 10 of embodiments such as those shown in FIGS. 1A and 1B may be prepared according to the process 24. The process begins with a roll of carrier film that forms the first carrier layer 16. The carrier film may be a printable carrier film. The printable carrier film (and thus the first carrier layer 16) may be a plastic film or foil, release liner, parchment, or any suitable variety of paper (light weight, heavyweight, coated, uncoated, etc.). The indicia layer 22 may then be laid down (e.g., applied) on top of the first carrier layer 16 by an indicia roller/cylinder 26, for example. It should be understood that the use of a roller or cylinder to apply the indicia layer 22 and other layers (described below) is merely an example of a way of applying various layers to the label 10. Any other known apparatus and/or process for applying the materials of the various layers can be used (e.g., printing plate, digital printing, inkjet printing, etc.). Additionally, the same or different application apparatuses and/or processes could be used for each of the various layers of the label 10. The indicia of the indicia layer 22 is applied (e.g., printed) using any printing process including (but not limited to): offset, flexography, rotogravure, letterpress, digital, ink jet, screen, intaglio, heat transfer, and/or photo graphic. Further, the pressure-sensitive label 10 and process 24 depicted in FIG. 2 allow for the incorporation of standard printing effects such as combination printing (e.g., the use of gravure printing in combination with flexographic printing in a single press production), the use of cold-foil and hot-foil decoration (which will be described in greater detail below), pattern embossing such as Fresnel lenses and holographic images, rotary screen (which will be described in greater detail below), RFID placement, and/or any embellishment currently or in the future available for use with conventional pressure-sensitive label production.

Then, the adhesive layer 20 may be laid down on top of the indicia layer 22 by an adhesive application roller/cylinder 28, for example. The adhesive chemistry utilized can include any adhesive technology capable to being applied in a pattern duplicating the size and shape of the label 10. After laying down the indicia layer 22 and adhesive layer 20, a second carrier layer 18 may be applied on top of the adhesive layer 20 by a carrier film application roller/cylinder 30, for example. Thus, a label 10 with these separate and distinct layers (e.g., 16, 18, 20, 22) is formed. In the embodiments where one or more of these layers (e.g., 20, 22) is UV-curable, they may be exposed to UV radiation provided by ultraviolet light, which cures the various UV-curable layers. This UV-curing may be done as each separate UV-curable layer is laid down, or it may occur after all UV-curable layers have been laid down.

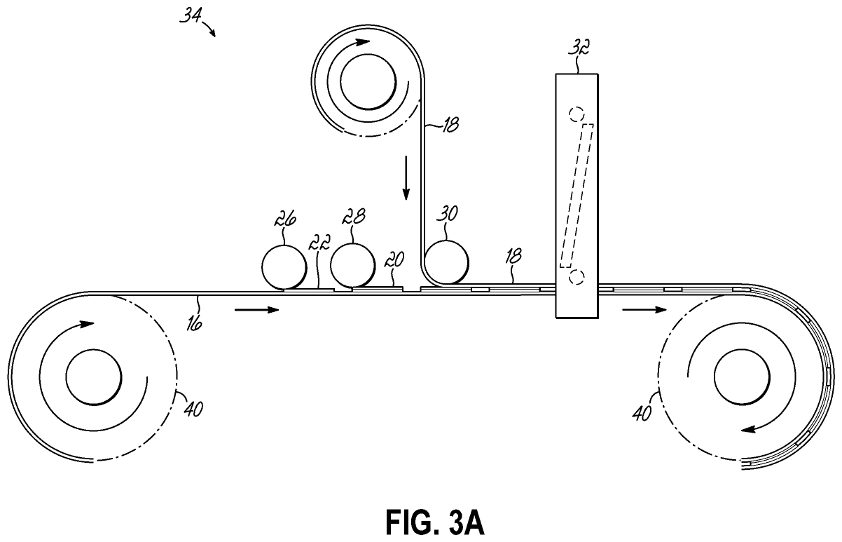

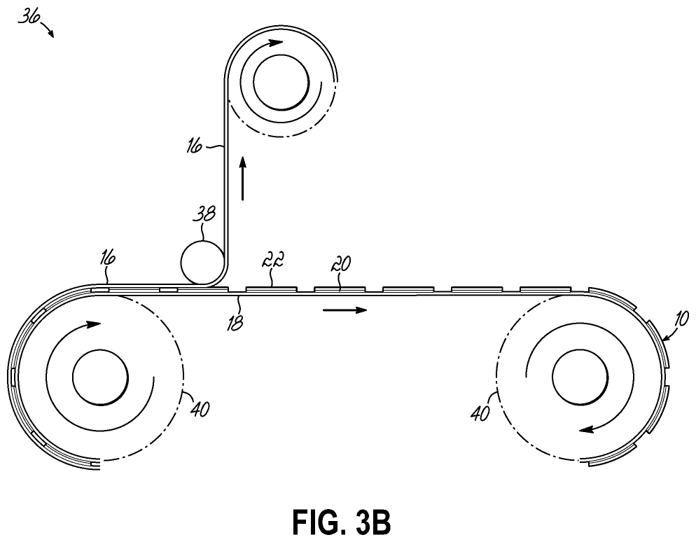

With continued reference to FIG. 2, following application of the second carrier layer 18 to form the label 10, the pressure-sensitive label 10 enters into a turn bar 32, for example. The turn bar 32 flips the orientation of the pressure-sensitive label 10 such that the first carrier layer 16 becomes the top layer (e.g., is located on the top of the pressure-sensitive label 10 construction) and the second carrier layer 18 becomes the bottom layer (e.g., is located on the bottom of the pressure-sensitive label 10). The flip of the pressure-sensitive label 10 by the turn bar 32 concludes a first portion 34 of the process 24. As will be described in greater detail below (with reference to FIGS. 3A and 3B, for example), the process 24 can be separated into first and second portions 34, 36. Further, it should be understood that if the process 24 is separated into first and second portions 34, 36, it may be unnecessary to include the turn bar 32 in the process 24. Instead of using the turn bar 32 to flip the orientation of the label 10, the orientation of the label 10 could be flipped by winding the roll 40 at the end of the first portion 34 of the process 34 in a particular way or by unwinding the roll 40 at the start of the second portion 36 of the process 24 in a particular way. For example, the roll 40 at the start of the second portion 36 of the process 24 could be unwound in such a way that the roll 40 unwinds with the first carrier layer 16 as the top layer (e.g., is located on the top of the pressure-sensitive label 10 construction) and the second carrier layer 18 as the bottom layer (e.g., is located on the bottom of the pressure-sensitive label 10). In short, one of ordinary skill in the art will appreciate that a turn bar 32 may not be necessary to flip the orientation of the label 10 in certain applications.

The second portion 36 of the process 24 begins with the removal of the first carrier layer 16 (e.g., the top layer of the flipped pressure-sensitive label 10) by a carrier film removal roller/cylinder 38, for example. As will be described in greater detail below, removal of the first carrier layer 16 exposes the indicia layer 22 such that further printing and/or embellishment (or similar—gloss, for example) can be applied to the pressure-sensitive label 10. In other words, removal of the first carrier layer 16 allows for the label 10 construction to be further enhanced (e.g., with additional aesthetically pleasing elements). The finished pressure-sensitive labels 10 are then wound onto a roll 40 (e.g., to be transported to a customer). In FIG. 2, this take-up roll 40 is the roll at the right side of the figure.

With continued reference to FIG. 2, there are several aspects of this process 24 not used in current conventional pressure-sensitive labels, or in current convention processes for constructing same, including, but not limited to: (1) the application of the second carrier layer 18, (2) the flipping of the pressure-sensitive label 10 construction by the turn bar 32 during the process 24 of creating the label 10, (3) subsequent removal of the first carrier layer 16 to allow the dispensing or application of additional elements (e.g., graphical elements) onto the label 10 using conventional pressure-sensitive applicator approaches (e.g., methods, technology, and/or machinery), and (4) printing (or otherwise applying) additional graphic elements onto the pressure-sensitive label 10 construction following the flip of the label 10. It is envisioned that the label 10 construction could be produced by various systems including, but not limited to: UV ink systems, digital ink systems (including inkjet and others), and/or gravure ink systems.

Referring now to FIGS. 3A and 3B, these figures show the first portion 34 (FIG. 3A) and the second portion 36 (FIG. 3B) of the embodiment of the process 24 shown in FIG. 2, respectively. As briefly mentioned above, the process 24 can be split into (at least) two portions—a first portion 34 (FIG. 3A) and a second portion 36 (FIG. 3B). It is to be understood that the portions 34, 36 of the process 24 can be performed separately, at different times and at different locations, if desired. In other words, the process 24 does not need to be completed all at once or entirely at the same location (though it could be). The first portion 34 of the process 24 and the second portion 36 of the process 24 could be performed as separate, independent operations. For example, the first portion 34 of the process 24 could be completed at a manufacturing facility while the second portion 36 of the process 24 could be completed at a customer's facility. Such may be desirable if a particular customer may desire to add additional graphical elements, embellishments, etc. beyond what is provided by a manufacturer, for example. Thus, capability of the process 24 to be split into a first portion 34 and a second portion 36 is advantageous.

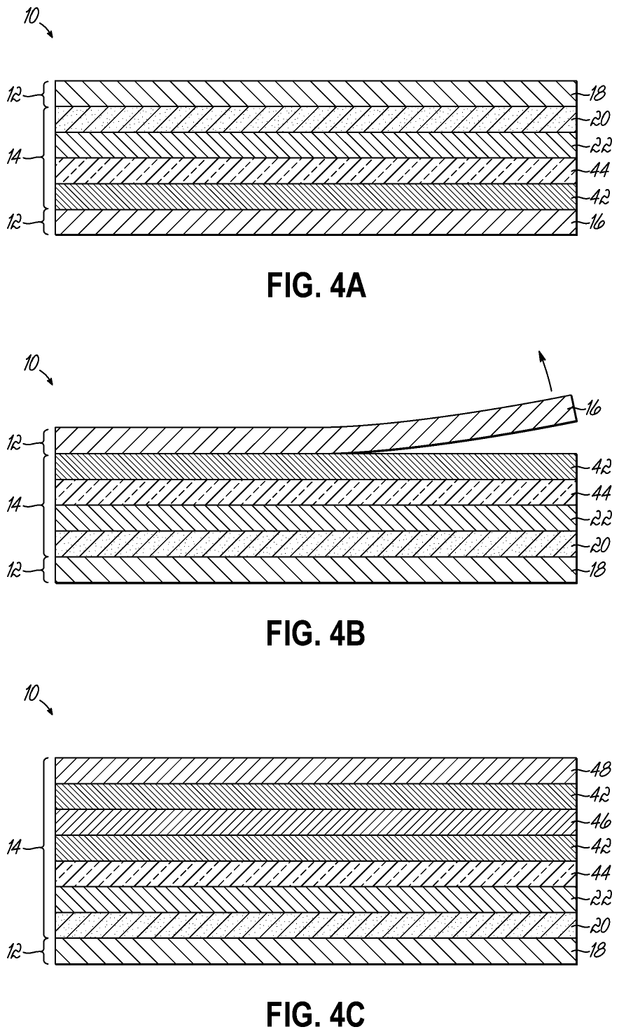

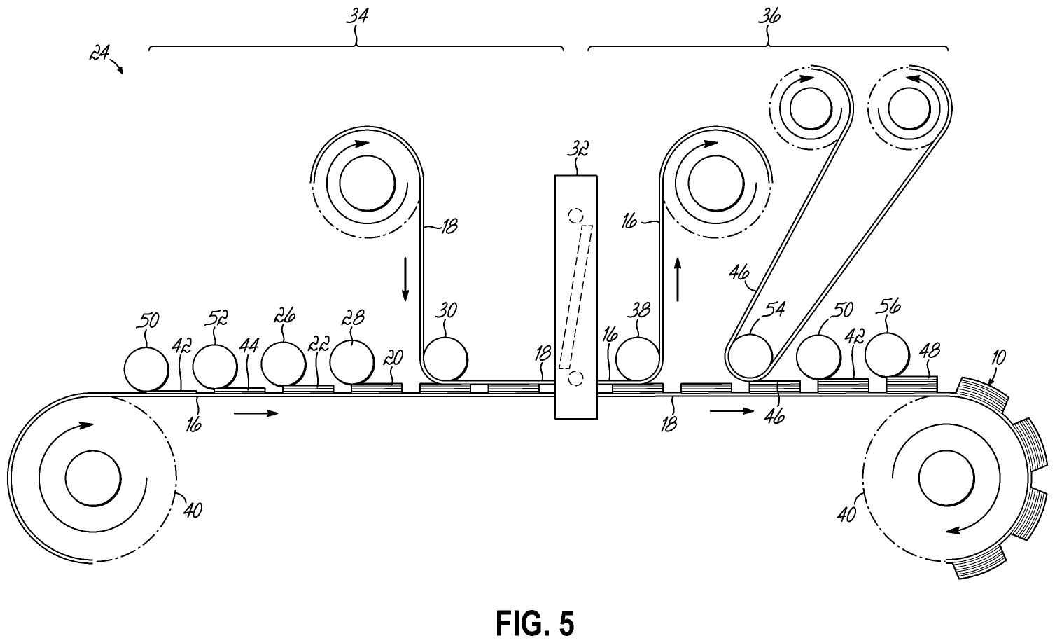

Referring now to FIGS. 4A-4C, the figures show further embodiments of a pressure-sensitive label 10 in accordance with principles of the present invention. Particularly, FIG. 4A shows the pressure-sensitive label 10 construction before the construction is flipped by the turn bar 32 in process 24 (shown in FIG. 5, for example) and FIGS. 4B and 4C show the pressure-sensitive label 10 construction after the label 10 is flipped by the turn bar 32 in process 24 (shown in FIG. 5, for example). The label 10 depicted in FIGS. 4A-4C differs from the label 10 depicted in FIGS. 1A and 1B. Particularly, the label 10 shown in FIGS. 4A-4C includes a number of additional layers—at least one layer of varnish 42 (also known as an “overprint coating”, “overprint lacquer”, “protective lacquer” or similar to those of ordinary skill in the art; typically “overprint” coatings or layers are those that lie over, and protect, graphics of a label when the label is applied to an article, such as a container), a printable layer 44, cold foil 46 (FIG. 4C), and screen printed graphics 48 (FIG. 4C), for example. However, the label 10 construction does not require all of these additional various layers shown in FIGS. 4A-4C. It will be understood that the label 10 could include more or fewer layers than is shown in FIGS. 4A-4C.

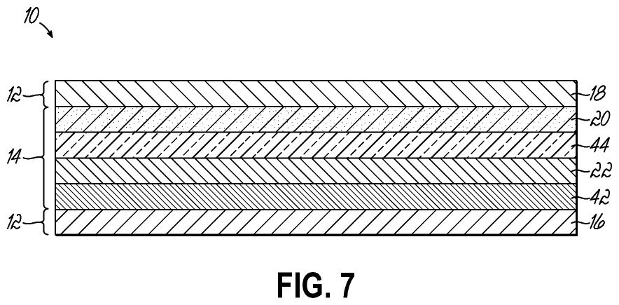

The process 24 allows for significant variation in preparing a label 10. For example, and as shown in FIGS. 4A-4C, one or more overprint varnish 42 layers could be added to the label 10 before the indicia layer 22 is applied (as is the case in FIG. 4A, for example) or after the indicia layer 22 is applied, if desired. The varnish 42 generally provides a protective coating layer to protect layers beneath the varnish 42. The varnish 42 may be a clear coating. Additionally, the varnish 42 may serve as a base and foundation for other (e.g., printed) layers or elements (e.g., as shown in FIG. 4A). The varnish 42 may be of various chemistries including UV curable, solvent, aqueous, and similar, for example, as will be understood by one of ordinary skill in the art. Further, the varnish 42 may be applied or printed by various means including flexographically, gravure, digitally, and similar, for example, as will be understood by one of ordinary skill in the art. Further, a varnish 42 layer could be applied after the first carrier film 16 is removed from the label 10 (as shown in FIG. 4C, for example). It is to be understood that other layers of the label 10 could also be applied in a different order or not at all. In other words, it is envisioned that the layers of the label 10 shown in FIGS. 4A-4C could be rearranged (see FIG. 7, for example) or omitted without deviating from the aspects of this disclosure.

With continued reference to FIGS. 4A-4C, the label 10 includes a printable layer 44 (also known as a an “overprint layer” or similar to those of ordinary skill in the art). In certain embodiments, the printable layer 44 may be clear. Such a clear printable layer may be useful in providing a “no-label” look, as it will be less visible (so that the label will have the appearance of inks, graphics, text, etc, printed onto the article, such as a container). It is to be understood that the printable layer 44 could alternatively be a colored printable layer 44—the color of the printable layer matching the color of the article the label 10 is to be applied to, for example. The color of the printable layer could also be different than the underlying container, though a clear, or “same color,” printable layer allows one to produce a label that provides a “no-label” look when applied. The label 10 construction does not require a printable layer 44; however, the printable layer 44 may be used, as shown in FIGS. 4A-4C, if it is advantageous or desired to provide body or structure to the label 10 construction.

The printable layer 44 coating is a thin (e.g., about 1 micron to about 50 microns in thickness—thinner than a typical face stock layer), dispensable pattern applied filmic substance. The printable layer 44 may be applied in a softened, molten, thixotropic, liquid, or similar (non-solid) form that then becomes a thin solid layer. Particularly, after solidifying into a thin layer, the printable layer 44 may be about 10 microns in thickness. This is more thin than a typical “thin” face stock layer which may be approximately 40 microns thick. The printable layer 44 may be applied as a pattern (such as in the shape, size, contour, etc. of a label that is to be produced) rather than being provided as a face stock that matches (or substantially matches) the area of the carrier layer 16 (as in traditional pressure-sensitive labels that include a face stock layer). The ability to apply the printable layer 44 in a pattern also reduces the amount of material that is needed for the web of labels (thereby reducing cost) and eliminates the need for die cutting (and the waste of the discarded die cut material).

With continued reference to FIGS. 4A-4C, the printable layer 44 is of a formulation that allows it to receive ink thereon following cooling, solidifying, UV-curing, etc. For example, the printable layer 44 may include a material formulated from a base resin. This base resin may, in various embodiments, be chosen from vinyls, acrylics, urethanes, epoxys, polyesters, and alkyds. Further, the printable layer 44 may be solvent-based, water-based, or ultraviolet curable-based. The printable layer 44, including these solvent-based, water-based, and/or UV curable-based chemistries (which are formulated from the base resins), may be formulated into a printable liquid at the viscosity and rheology applicable to various printing processes (such as screen printing, ink-jet printing, flexographic printing, rotogravure printing, and lithographic printing, for example).

The printable layer 44 in one embodiment is located between a varnish 42 layer and the printed indicia layer 22 (e.g., in FIG. 4A). However, the printable layer 44 may be alternatively located. For example, in FIG. 7 the printable layer 44 is located between the printed indicia layer 22 and the adhesive layer 20. In either construction, the printable layer 44 adds body or structure to the label 10 construction in the absence of a face stock layer. However, it is to be understood that the printable layer 44 may be excluded from the construction of the label 10 (as in FIGS. 1A and 1B, for example) without departing from the aspects of this disclosure.

With specific reference to the aspect of adding aesthetically pleasing elements to the label 10, the process 24 broadly outlined above with reference to FIG. 2 allows for the addition of a number of graphic elements to the label 10 to enhance the construction (as explained below with reference to FIG. 5, for example). Particularly, those elements can be added to the label 10 in the second portion 36 of the process 24. Once the first carrier layer 16 is removed, the indicia layer 22 is available for further modification. For example, as shown in FIG. 4C, after the first carrier layer 16 is removed from the label 10, additional graphic features such as cold foil 46 and screen printed graphics 48 could be added. Further, other additional graphic features that could be applied include (but are not limited to): digital printed graphic elements, tactile elements, additional overprint varnish layers, and/or a combination of some or all of the previously described graphics features. Additionally, the additional graphics features could be incorporated by using other print technologies such as digital inkjet printed features.

Referring now to FIG. 5, the pressure-sensitive label 10 of embodiments such as those shown in FIGS. 4A-4C may be prepared according to the process 24 depicted in FIG. 5. The process 24 depicted in FIG. 5 builds upon the process 24 depicted in FIG. 2. Duplicative aspects of the process 24 depicted in FIG. 5 may be omitted for sake of brevity. And, as mentioned above with reference to FIGS. 4A-4C, not all aspects of the process 24 depicted in FIG. 5 are necessary. Furthermore, those skilled in the art will appreciate that, in alternative embodiments, the various layers of the label 10 may be applied in a different order than is shown in FIG. 5 (or be omitted entirely).

As with the process 24 shown above in FIG. 2, the process 24 shown in FIG. 5 begins with a roll of printable carrier film that forms the first carrier layer 16. The first carrier layer 16 passes through a varnish application roller/cylinder 50 that applies varnish 42 to the first carrier layer 16. The first carrier layer 16 then passes through a printable layer application roller/cylinder 52. Again, as described above, it should be understood that the use of a roller or cylinder to apply the various layers is merely an example of a way of applying various layers to the label 10. Any other known apparatus and/or process for applying the materials of the various layers can be used (e.g., printing plate, digital printing, inkjet printing, etc.). Additionally, the same or different application apparatuses and/or processes could be used for each of the various layers of the label 10. The printable layer application roller/cylinder 52 applies a printable layer 44 atop the varnish 42 on the first carrier layer 16. The top surface of the first carrier layer 16 has a surface tension low enough to allow the printable layer 44 to releasably bond to the first carrier layer 16. This may be accomplished using non-treated films or can alternatively be accomplished using chemical treatments such as silicones and waxes. Further, the printable layer 44 is a thin, dispensable pattern applied filmic substance. The printable layer 44 could include (but is not limited to): solvent-based, water-based, and/or ultraviolet-curable based chemistries. Such chemistries are formulated from base resins including (but not limited to): vinyl, acrylic, urethane, epoxy, polyester, and/or alkyd and are formulated into a printable liquid at the viscosity and rheology applicable to the appropriate screen, ink jet, or flexo printing processes.

With continued reference to FIG. 5, the first carrier layer 16 then passes through the indicia application roller/cylinder 26. As described above with respect to FIG. 2, the indicia application roller/cylinder 26 applies the indicia layer 22. However, in the process 24 depicted in FIG. 5, the indicia layer 22 is applied atop the printable layer 44. The indicia is printed using any printing process including (but not limited to): offset, flexography, rotogravure, letterpress, digital, ink jet, screen, intaglio, heat transfer, and/or photo graphic. Further, the pressure-sensitive label 10 and process 24 depicted in FIG. 5 allow for the incorporation of standard printing effects such as combination printing (e.g., the use of gravure printing in combination with flexographic printing in a single press production), the use of cold-foil and hot-foil decoration (which will be described in greater detail below), pattern embossing such as Fresnel lenses and holographic images, rotary screen, RFID placement, and/or any embellishment currently or in the future available for use with conventional pressure-sensitive label production.

The first carrier layer 16 then passes through an adhesive application roller/cylinder 28. The adhesive application roller/cylinder 28 applies an adhesive layer 20 (e.g., a pressure-sensitive adhesive) atop the indicia layer 22. The adhesive chemistry utilized for the adhesive layer 20 can include any adhesive technology capable of being applied in a pattern duplicating the size and shape of the pressure-sensitive label 10. After the application of the adhesive layer 20, a second carrier layer 18 is applied atop the adhesive layer 20 by the carrier film application roller/cylinder 30.

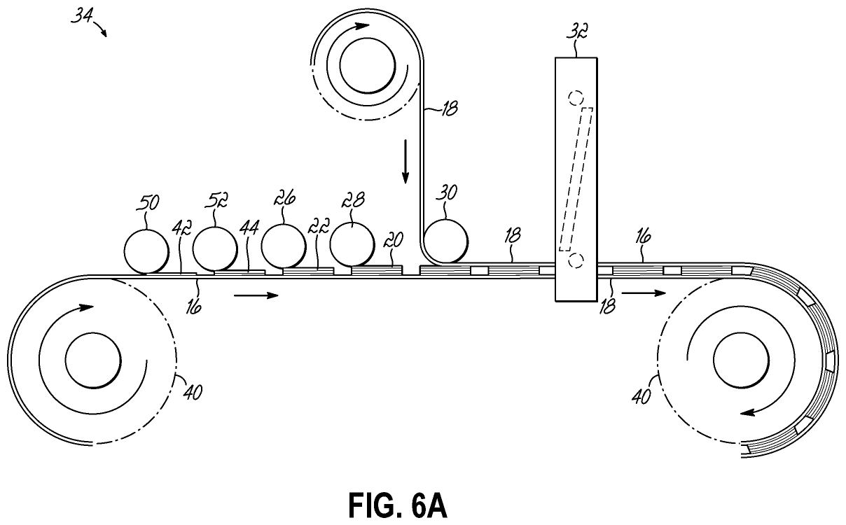

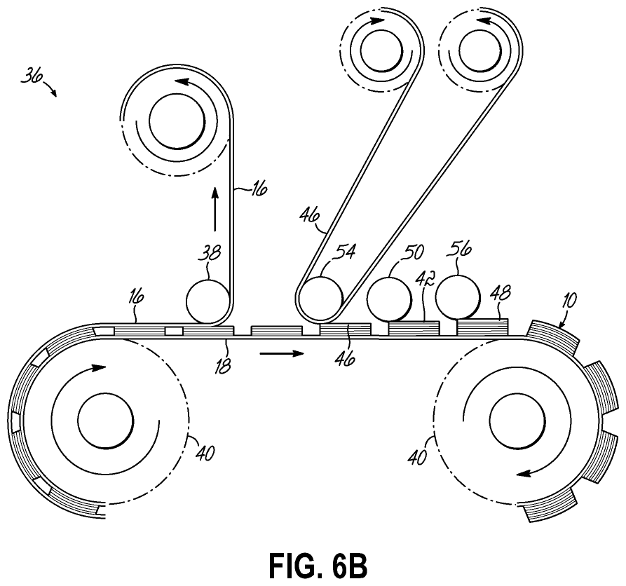

With continued reference to FIG. 5, following application of the second carrier layer 18, the pressure-sensitive label 10 enters into a turn bar 32. The turn bar 32 flips the orientation of the pressure-sensitive label 10 such that the first carrier layer 16 becomes the top layer (e.g., is located on the top of the pressure-sensitive label 10) and the second carrier layer 18 becomes the bottom layer (e.g., is located on the bottom of the pressure-sensitive label 10). The flip of the pressure-sensitive label 10 by the turn bar 32 concludes the first portion 34 of the process 24. Like the process 24 described above with respect to FIG. 2, the process 24 depicted in FIG. 5 can also be separated into first and second portions 34, 36—shown in FIGS. 6A and 6B, respectively.

The second portion 36 of the process 24 begins with the removal of the first carrier layer 16 (e.g., the top layer of the flipped pressure-sensitive label 10). Removal of the first carrier layer 16 exposes the varnish 42 and the indicia layer 22 below the varnish 42 such that further printing and/or embellishment (or similar) can be applied to the pressure-sensitive label 10. In other words, removal of the first carrier layer 16 allows for the pressure-sensitive label 10 construction to be further enhanced (e.g., with additional graphics). For example, following removal of the first carrier layer 16, cold foil 46 may be added to the pressure-sensitive label 10 by a foil application roller/cylinder 54. The process 24 may continue by then passing the pressure-sensitive label 10 construction through another varnish application roller/cylinder 50 that applies additional varnish 42 to protect the cold foil 46, for example. The pressure-sensitive label 10 may then pass through a rotary screen 56 that applies screen printed graphics 48 atop the (additional) varnish 42 layer. The application of the screen printed graphics 48 by the rotary screen 56 concludes the second portion 36 of the process 24 depicted in FIG. 5. The finished pressure-sensitive labels 10 can then be wound onto a roll 40 (e.g., to be transported to a customer).

With continued reference to FIG. 5, again there are several aspects of this process 24 including, but not limited to: (1) the application of the second carrier layer 18, (2) the flipping of the pressure-sensitive label 10 construction by the turn bar 32 during the process 24 of creating the label 10, (3) subsequent removal of the first carrier layer 16 to allow the dispensing or application of additional elements (e.g., graphical elements) onto the label 10 using conventional pressure-sensitive applicator approaches (e.g., methods, technology, and/or machinery), and (4) printing (or otherwise applying) additional graphic or foil or similar elements onto the pressure-sensitive label 10 construction following the flip of the label 10. It is envisioned that the label 10 construction could be produced by various processes including, but not limited to: UV ink systems, digital ink systems (including inkjet and others), and/or gravure ink systems.

With specific reference to aspect of adding additional graphic elements to the label 10, the process 24 broadly outlined above with reference to FIG. 5 allows for the addition of a number of graphic or other aesthetically pleasing elements to the label 10 to enhance the construction. Particularly, those elements can be added to the label 10 in the second portion 36 of the process 24. Once the first carrier layer 16 is removed, the indicia layer 22 is available for further modification. For example, as shown in FIG. 4C, after the first carrier layer 16 is removed from the label 10, additional graphic features such as cold foil 46 and screen printed graphics 48 could be added. Further, other additional graphic features that could be applied include (but are not limited to): digital printed graphic elements, tactile elements, additional overprint varnish layers, and/or a combination of some or all of the previously described graphics features. Additionally, the additional graphics features could be incorporated by using other print technologies such as digital inkjet printed features.

Referring now to FIGS. 6A and 6B, these figures show the first portion 34 (FIG. 6A) and the second portion 36 (FIG. 6B) of the embodiment of the process 24 shown in FIG. 5, respectively. As mentioned above with respect to FIGS. 3A and 3B, the process 24 can be split into (at least) two portions—a first portion 34 (FIG. 6A) and a second portion 36 (FIG. 6B). It is to be understood that the portions 34, 36 of the process 24 can be performed separately, at different times and at different locations, if desired. In other words, the process 24 does not need to be completed all at once or entirely at the same location. Further, the figures illustrate that the second portion 36 of the process 24 can vary, depending on client desires, for example. Particularly, FIG. 6B shows the addition of a cold foil 46 element by a foil application roller/cylinder 54 and the addition of a screen printed graphics 48 by a rotary screen 56 (which are not included in FIG. 3B, for example).

Referring generally to FIGS. 1A-7, the label 10 construction may have a number of variations without departing from the aspects of this disclosure. Particularly, the pressure-sensitive label 10 may have more or fewer layers than is shown in the embodiments depicted in FIGS. 1A and 1B or 4A-4C, respectively, without departing from the aspects of this disclosure. Further, the layers of the pressure-sensitive label 10 may be arranged in an order different than is shown in FIGS. 1A and 1B or 4A-4C, respectively, without departing from the aspects of this disclosure. Thus, the process 24 shown in FIGS. 2 and 5, respectively, may also vary according to the desired construction of the label 10 without departing from the aspects of this disclosure. For example, the rollers/cylinders 26, 28, 30, 38, 50, 52, 54, 56 may be alternatively arranged (e.g., in a different order) and/or some number of the rollers/cylinders 26, 28, 30, 38, 50, 52, 54, 56 may be added or removed from the process 24.

Further, certain layers of the pressure-sensitive label 10 may be made with UV-curable materials (and in some embodiments, all the layers may include UV-curable materials). UV-curable materials are generally known to those of ordinary skill in the art. Additionally, the chemistry of the label 10 construction may vary. For example, the first carrier layer 16 may include a release layer. In addition or alternatively, the second carrier layer 18 may also include a release layer which could be in contact with the adhesive layer 20. The second carrier layer 18 could also include a second release layer or treatment (e.g., a silicone release coating added before or during the printing process) on an opposing surface such that when the labels 10 are wound in a roll 40, the second release layer contacts the outermost surface of the final label 10 construction. Such an arrangement helps to prevent inks and adhesives from adhering to the opposing surface (e.g., back) of the second carrier layer 18. Thus, the addition of the second release layer or treatment provides the advantage of reducing the potential for “blocking” (i.e., where the label may inadvertently transfer to an opposing surface) in the roll 40. This allows the finished product to be wound into a roll 40 and subsequently unwound during the label 10 application process. Alternatively, the second carrier layer 18 could have no release layer, one release layer on one side, or a release layer on both sides. If release layers are applied to both sides, the release layers could be identical or different from each other. In other words, the first and second release layers could have different release values, if desired. Additionally, the release layers could be continuous, covering substantially the entire second carrier layer 18, or alternatively, can be applied in such a way that they are only in the area of the labels 10.

While the present invention has been illustrated by the description of various embodiments and while these embodiments have been described in some detail, it is not the intention of the Applicant to restrict or in any way limit the scope of the invention to such detail. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A pressure-sensitive label, comprising:
a support portion including a carrier layer; and
a transfer portion operatively connected to the support portion, the transfer portion including at least an adhesive layer and an indicia layer, the transfer portion configured for transfer of the transfer portion from the support portion to an article upon application of pressure to the transfer portion while the transfer portion is in contact with the article,
wherein the transfer portion does not include a face stock layer.

2. The pressure-sensitive label of claim 1, wherein the transfer portion includes a printable layer.

3. The pressure-sensitive label of claim 2, wherein the printable layer is positioned such that the printable layer is between the indicia layer and the adhesive layer.

4. The pressure-sensitive label of claim 2, wherein the printable layer is clear.

5. The pressure-sensitive label of claim 1, wherein the transfer portion includes a varnish layer.

6. The pressure-sensitive label of claim 5, wherein the transfer portion includes a printable layer, and wherein the printable layer is positioned such that the printable layer is located between the varnish layer and the indicia layer.

7. The pressure-sensitive label of claim 5, wherein the transfer portion includes a foil layer, the foil layer separate from the indicia layer.

8. The pressure-sensitive label of claim 5, wherein the transfer portion includes a screen printed graphics layer, the screen printed graphics layer separate from the indicia layer.

9. The pressure-sensitive label of claim 5, wherein the varnish layer includes a first varnish layer and a second varnish layer, the first varnish layer separate from the second varnish layer.

10. The pressure-sensitive label of claim 1, wherein the carrier layer includes a first carrier layer and a second carrier layer, and wherein the transfer portion is positioned such that the transfer portion is between the first carrier layer and the second carrier layer.

11. A method of making a pressure-sensitive label, the method comprising:
providing a first carrier layer;
applying an indicia layer atop the first carrier layer;
applying an adhesive layer atop the indicia layer; and
applying a second carrier layer atop the adhesive layer,
wherein the first carrier layer and the second carrier layer form a support portion, and
wherein the indicia layer and the adhesive layer form at least a portion of a transfer portion, the transfer portion configured for transfer of the transfer portion to an article upon application of pressure to the transfer portion while the transfer portion is in contact with the article.

12. The method of making a pressure-sensitive label of claim 11, the method further comprising, prior to the step of applying the second carrier layer:
applying a first varnish layer atop the first carrier layer; and
applying a printable layer atop the first varnish layer,
wherein the first varnish layer and the printable layer form at least a portion of the transfer portion.

13. The method of making a pressure-sensitive label of claim 12, wherein the printable layer is positioned such that the printable layer is between the first varnish layer and the indicia layer.

14. The method of making a pressure-sensitive label of claim 12, wherein the printable layer is positioned such that the printable layer is between the indicia layer and the adhesive layer.

15. The method of making a pressure-sensitive label of claim 11, the method further comprising, after the step of applying the second carrier layer:
flipping an orientation of the pressure-sensitive label.

16. The method of making a pressure-sensitive label of claim 15, wherein the orientation of the pressure-sensitive label is flipped by a turn bar.

17. The method of making a pressure-sensitive label of claim 15, the method further comprising, after the step of flipping the orientation of the label:
removing the first carrier layer; and
applying at least one first label enhancement layer atop the indicia layer,
wherein the at least one first label enhancement layer forms at least a portion of the transfer portion.

18. The method of making a pressure-sensitive label of claim 17, wherein the at least one first label enhancement layer includes foil.

19. The method of making a pressure-sensitive label of claim 17, the method further comprising, after the step of applying at least one first label enhancement layer:
applying a second varnish layer atop the at least one at least one first label enhancement layer,
wherein the second varnish layer forms at least a portion of the transfer portion.

20. The method of making a pressure-sensitive label of claim 19, the method further comprising, after the step of applying a second varnish layer:
applying at least one second label enhancement layer atop the second varnish layer,
wherein the at least one second label enhancement layer forms at least a portion of the transfer portion.

21. The method of making a pressure-sensitive label of claim 20, wherein the at least one second label enhancement layer includes screen printed graphics.
